(19) United States
(12) Patent Application Publication
(10) Pub. No.: US 2011/0173265 A1
(43) Pub. Date: Jul. 14, 2011

(54) MULTI-HEAD HIERARCHICALLY CLUSTERED PEER-TO-PEER LIVE STREAMING SYSTEM

(75) Inventors: Chao Liang, Brooklyn, NY (US); Yang Guo, West Windsor, NJ (US); Yong Liu, Brooklyn, NY (US)

(73) Assignee: Thomson Licensing LLC, Princeton, NJ (US)

(21) Appl. No.: 12/993,412

(22) PCT Filed: May 28, 2008
(86) PCT No.: PCT/US2008/006721

§ 371 Date: Mar. 18, 2011

(51) Int. Cl. G06F 15/16

(52) U.S. Cl. 709/205

(57) ABSTRACT

A method and apparatus are described including receiving data from a plurality of cluster heads and forwarding the data to peers. Also described are a method and apparatus including calculating a sub-stream rate, splitting data into a plurality of data sub-streams and pushing the plurality of data sub-streams into corresponding transmission queues. Further described are a method and apparatus including splitting source data into a plurality of equal rate data sub-streams, storing the equal rate data sub-streams into a sub-server content buffer, splitting buffered data into a plurality of data sub-streams, calculating a plurality of sub-stream rates and pushing the data sub-streams into corresponding transmission queues.

### FIELD OF THE INVENTION

The present invention relates to a peer-to-peer (P2P) live streaming system in which the peers are hierarchically clustered and further where each cluster has multiple cluster heads.

### BACKGROUND OF THE INVENTION

A prior art study described a “perfect” scheduling algorithm that achieves the maximum streaming rate allowed by the system. Assuming that there are n peers in the system. Let r^{max} denote the maximum streaming rate allowed by the system, we have:

$${r}^{max} = min \{ {u}_{s} , \frac{{u}_{s} + {\sum }_{i = 1}^{n} {u}_{i}}{n} \} \qquad ( 1 )$$

where uₓ refers to the upload bandwidth of server and uᵢ refers to the bandwidth of the ith node of total n nodes. That is, the maximum video streaming rate is determined by the video source server's capacity, the number of peers in the system and the aggregate uploading capacity of all the peers. Each peer uploads the video/content obtained directly from the video source server to all other peers in the system. To guarantee full uploading capacity utilization on all peers, different peers download different content from the server and the rate at which a peer downloads content from the server is proportional to its uploading capacity.

FIG. 1 shows an example how the different portions of data are scheduled among three heterogeneous nodes using the “perfect” scheduling algorithm of the prior art. There are three peers in the system. The server has a capacity of 6. The upload capacities of a₁, a₂ and a₃ are 2, 4 and 6 respectively. Suppose the peers all have enough downloading capacity, the maximum video rate that can be supported in the system is 6. To achieve that rate, the server divides video chunks into groups of 6. a₁ is responsible for uploading 1 chunk out of each group while a₂ and a₃ are responsible for upload 2 and 3 chunks out of each group. In this way, all peers can download video at the maximum rate of 6. To implement such a “perfect” scheduling algorithm, each peer needs to maintain a connection and exchange video content with all other peers in the system. In addition, the server needs to split the video stream into multiple sub-streams with different rates, one for each peer. A real P2P live streaming system can easily have a few thousand of peers. With current operating systems, it is unrealistic for a regular/normal peer to maintain thousands of concurrent connections. It is also challenging for a server to partition a video stream into thousands of sub-streams in real time. As used herein “/”, denotes the same of similar components or acts. That is, “/” can be taken to indicate alternative terms for the same or similar components or acts.

Instead of forming a single, large mesh, the hierarchically clustered P2P streaming scheme (HCPS) groups the peers into clusters. The number of peers in a cluster is relatively small so that the perfect scheduling can be successfully applied at the cluster level. One peer in a cluster is selected as the cluster head and works as the source for this cluster. The cluster heads receive the streaming content by joining an upper level cluster in the system hierarchy.

FIG. 2 illustrates a simple example of the HCPS system. In FIG. 2, the peers are organized into a two-level hierarchy. At the base/lowest level, peers are grouped into small size clusters. The peers are fully connected within a cluster. That is, they form a mesh. The peer with the largest upload capacity is elected as the cluster head. At the top level, all cluster heads and the video server form two clusters. The video server (source) distributes the content to all cluster heads using the “perfect” scheduling algorithm at the top level. At the base/lowest level, each cluster head acts as a video server in its cluster and distributes the downloaded video to other peers in the same cluster, again, using the “perfect” scheduling algorithm. The number of connections for each normal peer is bounded by the size of its cluster. Cluster heads additionally maintain connections in the upper level cluster.

In an earlier application, Applicants formulated the maximum streaming rate in HCPS as an optimization problem. The following three criteria were then used to dynamically adjust resources among clusters.
The discrepancy of individual clusters' average upload capacity per peer should be minimized.
Each cluster head's upload capacity should be as large as possible. The cluster head's capacity allocated for the base layer capacity has to be larger than the average upload capacity to avoid being the bottleneck. Furthermore, the cluster head also joins the upper layer cluster. Ideally, the cluster head's rate should be ≧2r^{HCPS}.
The number of peers in a cluster should be bounded from the above by a relative small number. The number of peers in a cluster determines the out-degree of peers, and a large size cluster prohibits a cluster from performing properly using perfect scheduling.

In order to achieve the streaming rate in HCPS close to the theoretical upper bound, the cluster head's upload capacity must be sufficiently large. This is due to the fact that a cluster head participates in two clusters: (1) the lower-level cluster where it behaves as the head; and (2) the upper-level cluster where it is a normal peer. For instance, in FIG. 2, peer a1 is the cluster head for cluster 3. It is also a member of upper-level cluster 1, where it is a normal peer.

Let r^{HCPS} denote the streaming rate of the HCPS system. As the cluster head, its upload capacity has to be at least C^{HCPS}. Otherwise the streaming rate of the lower-level cluster (where the node is the cluster head) will be smaller than r^{HCPS} and this cluster becomes the bottleneck. It reduces the entire system streaming rate. A cluster head is also a normal peer in the upper-level cluster. It is desirable that the cluster head can also contribute some upload capacity in the upper-level so that there is enough upload capacity resource in the upper-level cluster to support r^{HCPS}.

HCPS, thus, addresses the scalability issues faced by perfect scheduling. HCPS divides the peers into clusters and applies the “perfect” scheduling algorithm within individual clusters. The system typically has two levels. At the bottom/lowest level, each cluster has one cluster head to fetch content from upper level and acts as the source to distribute the content to the nodes in the cluster. The cluster heads then form a cluster at the upper level to fetch content from the streaming source. “Perfect” scheduling algorithm is used in all clusters. In this way, the system can achieve the streaming rate close to the theoretical upper bound.

In practice, due to the peer churn the clusters are dynamically re-balanced. Hence, the situation where may be encountered where no single peer in the cluster with large enough upload capacity to be its cluster head can be identified. Using multiple cluster heads reduces the requirement on the cluster head's upload capacity and the system can still achieve close to theoretical upper bound streaming rate. It would be advantageous to have a system for P2P live streaming where the base/lowest level clusters have multiple cluster heads.

### SUMMARY OF THE INVENTION

The present invention is directed to a P2P live streaming method and system in which peers are hierarchically clustered and further where each cluster has multiple heads. In the P2P live streaming method and system of the present invention, a source server serves content/data to hierarchically clustered peer. Content includes any form of data including audio, video, multimedia etc. The term video is used interchangeably with content herein but is not intended to be limiting. Further as used herein, the term peer is used interchangeably with node and includes computers, laptops, personal digital assistants (PDAs), mobile terminals, mobile devices, dual mode smart phones, set top boxes (STBs) etc.

Having multiple cluster heads facilitates the cluster head selection and enables the HCPS system to achieve high supportable streaming rate even if the cluster head's upload capacity is relatively small. The use of multiple cluster heads also improves the system robustness.

A method and apparatus are described including receiving data from a plurality of cluster heads and forwarding the data to peers. Also described are a method and apparatus including calculating a sub-stream rate, splitting data into a plurality of data sub-streams and pushing the plurality of data sub-streams into corresponding transmission queues. Further described are a method and apparatus including splitting source data into a plurality of equal rate data sub-streams, storing the equal rate data sub-streams into a sub-server content buffer, splitting buffered data into a plurality of data sub-streams, calculating a plurality of sub-stream rates and pushing the data sub-streams into corresponding transmission queues.

### BRIEF DESCRIPTION OF THE DRAWINGS

The present invention is best understood from the following detailed description when read in conjunction with the accompanying drawings. The drawings include the following figures briefly described below:

FIG. 1 is an example of how the different portions of data are scheduled among three heterogeneous nodes using the “perfect” scheduling algorithm of the prior art.

FIG. 2 illustrates a simple example of the HCPS system of the prior art.

FIG. 3 is an example of the eHCPS system of the present invention with two heads per cluster.

FIG. 4 depicts the architecture of a peer in eHCPS.

FIG. 5 is a flowchart of the data handling process of a peer.

FIG. 6 depicts the architecture of a cluster head.

FIG. 7 is a flowchart for lower-level data handling process of a cluster head

FIG. 8 depicts the architecture of the content/source server.

FIG. 9 is a flowchart illustrating the data handling process for a sub-server.

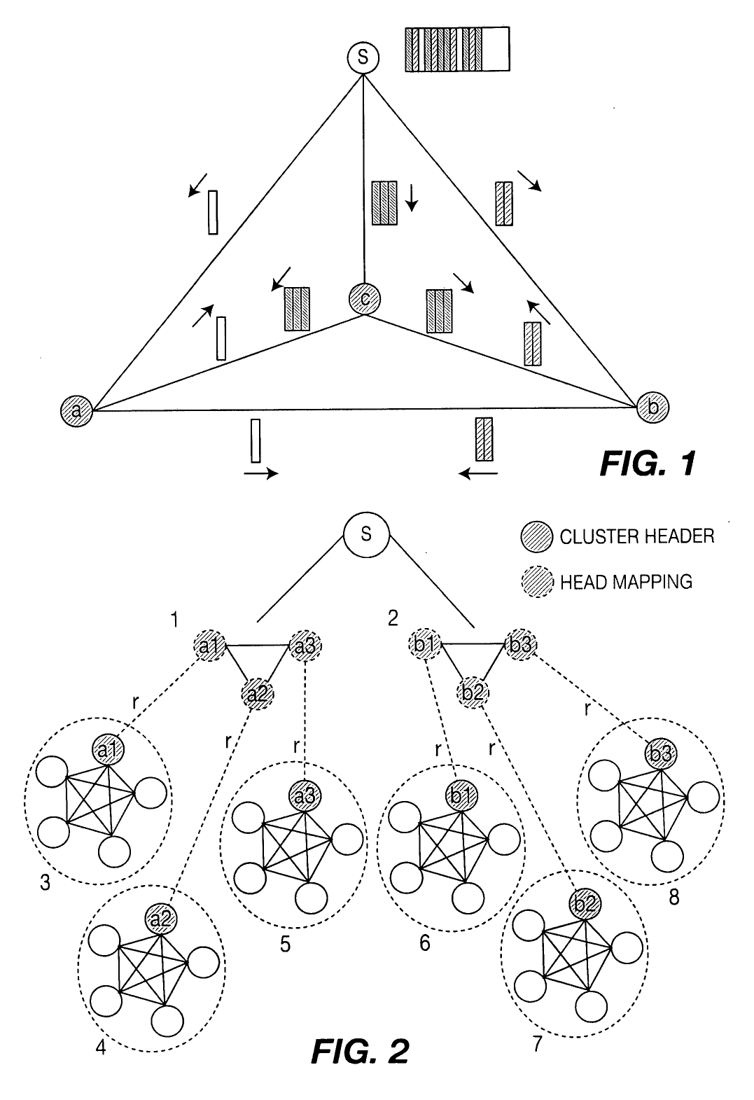

### DETAILED DESCRIPTION OF THE PREFERRED EMBODIMENTS

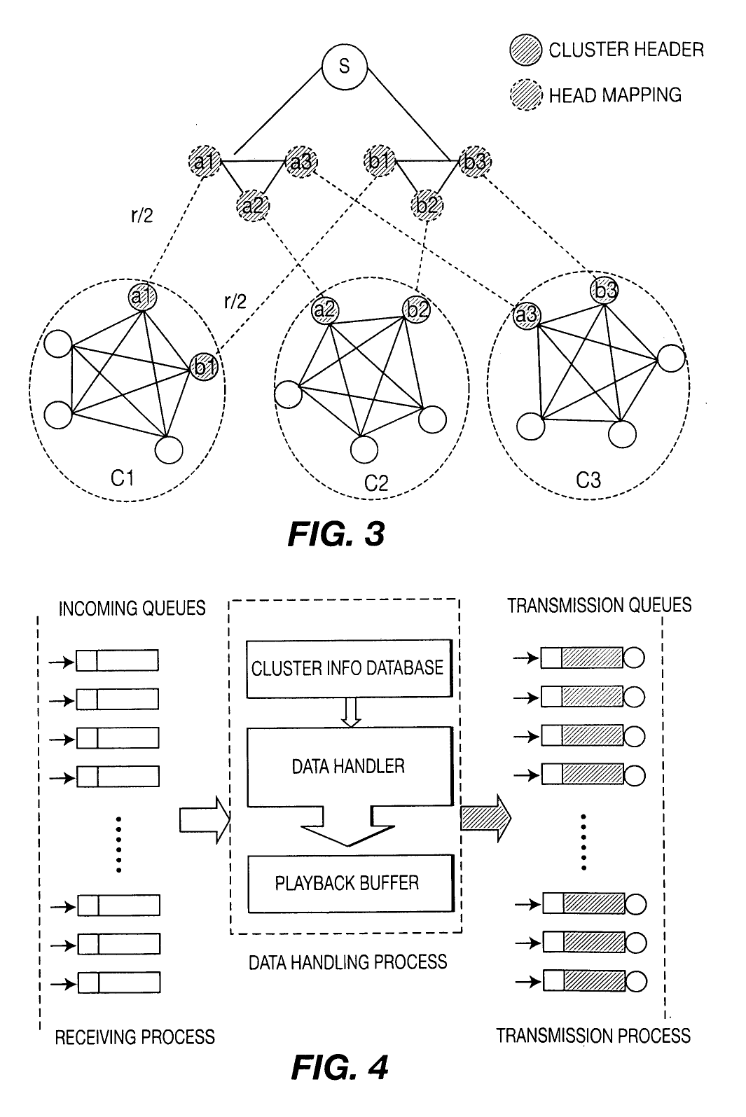

The present invention is an enhanced HCPS with multiple heads per cluster, referred to as eHCPS. The original content stream is divided into several sub-streams. Each cluster head handles one sub-stream. Suppose eHCPS supports K-heads per cluster, then the server needs to split the content into K sub-streams. FIG. 3 illustrates an example of eHCPS system with two heads per cluster. In this example, eHCPS splits the content into two sub-streams with equal streaming rate. Two heads of one cluster join in different upper-level clusters to fetch one sub-stream of data/content and then distributes the content that it received to the regular/normal nodes in the bottom/base/lowest level cluster. eHCPS does not increase the number of connections per node.

As shown in FIG. 3, assume the source stream is divided into K sub-streams. These K source sub-streams are delivered to cluster heads through K top-level clusters. Further assume there are C bottom-level clusters, and N peers. Cluster c has n_{c} peers, c=1, 2, . . . C. Denote by uᵢ peer i's upload capacity. A peer can participate in the HCPS mesh either as a normal peer, or as a cluster head in the upper layer cluster and a normal peer in the base layer cluster. In the following the eHCPS system with K cluster heads per cluster is formulated as an optimization problem where the object is to maximize r Streaming rate equals playback rate. Table I below lists some of the key symbols.

TABLE I

| | |
|---|---|
| uₛ | upload capacity of source server |
| n_{c} | number of peers in cluster c, excluding cluster heads |
| h_{ck}⁰ | upload capacity of the kth head of cluster c spent in top-level |
| | cluster |
| h_{ck}^{j} | upload capacity of the kth head of cluster c spent in the jth sub- |
| | stream in its own cluster |
| h_{ck} | total upload capacity of the kth head of cluster c |
| u_{cv} | upload capacity of node v in cluster c |
| u_{cv}^{j} | upload capacity of peer v in cluster c spent in the jth sub-stream |
| | distribution process |
| uₛ^{j} | upload capacity of source server spent in the jth top-level cluster |
| r | video streaming rate |

The optimization problem can be formulated as follows:

max r (2)

### Subject to:

$$\begin{matrix}\frac{r}{K} \leq \frac{{\sum }_{v} {u}_{cv}^{j} + {\sum }_{k} {h}_{ck}^{j}}{{n}_{c} + K - 1} ∀ j ∈ K , c ∈ C & ( 3 ) \\ \frac{r}{K} \leq \frac{{\sum }_{c} {h}_{cj}^{0} + {u}_{s}^{j}}{K} ∀ j ∈ K & ( 4 ) \\ {\sum }_{j} {h}_{ck}^{j} + {h}_{ck}^{0} \leq {h}_{ck} ∀ k ∈ K , c ∈ C & ( 5 ) \\ {\sum }_{j} {u}_{s}^{j} \leq {u}_{s} & ( 6 ) \\ {\sum }_{j} {u}_{cv}^{j} \leq {u}_{cv} ∀ c ∈ C , v ∈ {n}_{c} & ( 7 ) \\ \frac{r}{K} \leq {h}_{cj}^{j} ∀ j ∈ K , c ∈ C & ( 8 ) \\ \frac{r}{K} \leq {u}_{s}^{j} ∀ j ∈ K & ( 9 )\end{matrix}$$

The source server splits the source data equally into K sub-streams, each with the rate of r/K. The right side of Equation (3) represents the average upload bandwidth of all nodes in the bottom-level cluster c for the jth sub-stream. While the jth head functions as the source, cluster heads for other sub-streams need to fetch the j-th sub-stream in order to playback the entire video themselves. Equation (3) shows that the average upload bandwidth of a cluster has to be greater than the sub-stream rate for all sub-streams in all clusters. Specifically, the first term in the numerator (on the right hand side of the inequality) is the upload capacity of all peers in the cluster distributing the jth sub-stream. The second term in the numerator (on the right hand side of the inequality) is the upload capacity of the cluster heads spent in distributing the jth sub-stream. The sum of the two terms in the numerator (on the right hand side of the inequality) is divided by the number of nodes in the cluster n_{c} (not including the cluster heads) plus the number of cluster heads K less 1. Equation (8) shows that any sub-stream head's upload bandwidth has to greater than the sub-stream rate. Similarly, for the top-level cluster, the server is required to support K clusters, one cluster for each sub-stream. Both the upload capacity of the source server spent in the jth top-level cluster and the average upload bandwidth of individual clusters need to be greater than the sub-stream rate. Specifically, with respect to equation (4), the numerator (on the right hand side of the inequality) is the sum of the upload capacity of the source server spent in the jth top-level cluster and the sum of the upload capacity of the K cluster heads spent in the j-th top-level cluster. This sum is divided by the number of cluster heads to arrive at an average upload capacity of the individual cluster. With respect to equation (9), the upload capacity of the source server spent in the jth top-level cluster needs to be greater than the sub-stream rate. This explains Equations (4) and (9). Finally, as Equation (5) (6) and (7) represent, all nodes including the source server cannot spend more bandwidth than its own capacity. Specifically, equation (5) indicates that the upload capacity of the kth head of cluster c has to be greater than or equal to the total amount of bandwidth spent at both top-level cluster and the second-level cluster. In the second level cluster, k-th head of cluster c participates in the distribution of all sub-streams. Equation (6) indicates that the upload capacity of the source server is greater than or equal to the total upload capacity the source server spends in top-level clusters. Equation (7) indicates that the upload capacity of node v in cluster c is greater than or equal to the total upload bandwidth node v spent for all sub-streams. The use of multiple heads for one cluster can achieve the optimal streaming rate more easily than using a single cluster head. eHCPS relaxes the bandwidth requirement for the cluster head.

Suppose there is a cluster c with N nodes. Node p is the head. Node q is a normal peer in HCPS and becomes another head in multiple-head HCPS (eHCPS). With the HCPS approach, the supportable rate was:

$${r}_{c} = min \{ \overline{{u}_{p}} , \frac{{\sum }_{k ∈ {V}_{c} , k \neq p} {u}_{k} + {u}_{q} + \overline{{u}_{p}}}{N} \} , \qquad ( 10 )$$

where uₖ denotes the upload capacity of regular node k, uₚ refers to the upload capacity of the head p, ūₚ=uₚ−δ, where δ is the amount of upload bandwidth spent by the head p on the upper level. The second item of Equation (10) is the maximum rate the cluster can achieve with the head contributing δ amount of bandwidth to the upper-level cluster. Using rₚ to denote the second term at the right-hand side of Equation (10):

$${r}_{p} = \frac{{\sum }_{k ∈ {V}_{c} , k \neq p} {u}_{k} + {u}_{q} + \overline{{u}_{p}}}{N} = \frac{{\sum }_{k ∈ {V}_{c} , k \neq p} {u}_{k} + {u}_{q} + {u}_{p} - δ}{N} \qquad ( 11 )$$

In order to achieve the optimal streaming rate, the cluster heads must not be the bottlenecks, i.e.,

$$\overline{{u}_{p}} \geq \frac{{\sum }_{k ∈ {V}_{c} , k \neq p} {u}_{k} + {u}_{q} + \overline{{u}_{p}}}{N} ⇒ {u}_{p} - δ \geq \frac{{\sum }_{k ∈ {V}_{c} , k \neq p} {u}_{k} + {u}_{q} + {u}_{p} - δ}{N} ⇒ {u}_{p} \geq δ + {r}_{p} \qquad ( 12 )$$

In the following it is shown that the eHPCS approach reduces the upload capacity requirement for cluster head. Suppose the same cluster now switches to eHCPS with two heads (p and q) per cluster. The amount of bandwidth δ spent in the upper level is the same. Each cluster head distributes one sub-stream within the cluster using the perfect scheduling algorithm (p handles sub stream 1 and q handles sub-stream 2). Suppose uₖ¹ denotes the upload capacity of node k spent in the first sub-stream hosted by head p, and uₖ² denotes the upload capacity used by node k for the second sub-stream hosted by head q. Hence, the supportable sub-stream rate is:

$$\begin{matrix}{r}_{1} = min \{ {u}_{p}^{1} - δ / 2 , \frac{{\sum }_{k ∈ {V}_{c} , k \neq p , q} {u}_{k}^{1} + {u}_{p}^{1} + {u}_{q}^{1} - δ / 2}{N} \} & ( 13 ) \\ and & \\ {r}_{2} = min \{ {u}_{q}^{2} - δ / 2 , \frac{{\sum }_{k ∈ {V}_{c} , k \neq p , q} {u}_{k}^{2} + {u}_{p}^{2} + {u}_{q}^{2} - δ / 2}{N} \} . & ( 14 )\end{matrix}$$

where uₚ¹ and uₚ² are the upload capacity of cluster head p for sub-stream 1 and sub-stream 2, respectively. Similarly, u_{q}¹ and u_{q}² are the upload capacity of cluster head q for sub-stream 1 and sub-stream 2. If the capacities are evenly split, for the regular/normal nodes,

$${u}_{k}^{1} = {u}_{k}^{2} = \frac{1}{2} {u}_{k}$$

and for the two cluster heads,

$${u}_{p}^{1} = \frac{{r}_{p}}{2} + \frac{δ}{2} + \frac{{u}_{p} - {r}_{p} / 2 - δ / 2}{2} = \frac{{u}_{p} + {r}_{p} / 2 + δ / 2}{2} , \\ {u}_{p}^{2} = \frac{{u}_{p} - {r}_{p} / 2 - δ / 2}{2} , \\ {u}_{q}^{1} = \frac{{u}_{q} - {r}_{p} / 2 - δ / 2}{2} , {u}_{q}^{2} = \frac{{u}_{q} + {r}_{p} / 2 + δ / 2}{2} .$$

The cluster heads share the bandwidth δ on the upper level. uₚ¹ and u_{q}², each need to spend δ/2 extra bandwidth on upper level for the two sub streams individually. Applying the above bandwidth splitting, it can be shown that the second items in equation (13) and (14) are the same and they are equal to rₚ/2. As long as the cluster heads' upload capacities are not the bottlenecks, we have r₁+r₂=rₚ. For sub-stream 1, the condition for cluster head p not being the bottleneck is:

$${u}_{p}^{1} - δ / 2 \geq \frac{{\sum }_{k ∈ {V}_{c} , k \neq p , q} {u}_{k}^{1} + {u}_{p}^{1} + {u}_{q}^{1} - δ / 2}{N} ⇒ \frac{{u}_{p} + {r}_{p} / 2 - δ / 2}{2} \geq \frac{{\sum }_{k ∈ {V}_{c} , k \neq p , q} {u}_{k} / 2 + {u}_{p} / 2 + {u}_{q} / 2 - δ / 2}{N} ⇒ {u}_{p} \geq δ / 2 + {r}_{p} / 2 \qquad ( 15 )$$

Similarly, the condition for cluster head q not being bottleneck is

u_{q}≧δ/2+rₚ/2. (16)

Comparing Equations (15) (16) with Equation (12), it can be seen that the cluster heads' upload capacity requirement has been relaxed.

When eHPCS supports three cluster heads p, q and t for three sub streams, the splitting method can be as follows: for the regular nodes,

$${u}_{k}^{1} = {u}_{k}^{2} = {u}_{k}^{3} = \frac{1}{3} {u}_{k}$$

and for the cluster heads.

$${u}_{p}^{1} = \frac{{r}_{p}}{3} + \frac{δ}{3} + \frac{{u}_{p} - {r}_{p} / 3 - δ / 3}{3} = \frac{{u}_{p} + 2 {r}_{p} / 3 + 2 δ / 3}{3} , \\ {u}_{p}^{2} = {u}_{p}^{3} = \frac{{u}_{p} - {r}_{p} / 3 - δ / 3}{3} , \\ {u}_{q}^{2} = \frac{{r}_{p}}{3} + \frac{δ}{3} + \frac{{u}_{q} - {r}_{p} / 3 - δ}{3} = \frac{{u}_{q} + 2 {r}_{p} / 3 + 2 δ / 3}{3} , \\ {u}_{q}^{1} = {u}_{q}^{3} = \frac{{u}_{q} - {r}_{p} / 3 - δ / 3}{3}$$

$${u}_{t}^{3} = \frac{{r}_{p}}{3} + \frac{δ}{3} + \frac{{u}_{t} - {r}_{p} / 3 - δ / 3}{3} = \frac{{u}_{t} + 2 {r}_{p} / 3 + 2 δ / 3}{3} , \\ {u}_{t}^{1} = {u}_{t}^{2} = \frac{{u}_{t} - {r}_{p} / 3 - δ / 3}{3} .$$

In order for the cluster head to not be the bottleneck, the bandwidth of the cluster head should satisfy

$${u}_{p}^{1} - δ / 3 \geq \frac{{\sum }_{k ∈ {V}_{c} , k \neq p , q} {u}_{k}^{1} + {u}_{p}^{1} + {u}_{q}^{1} - δ / 3}{N} ⇒ \frac{{u}_{p} + 2 {r}_{p} / 3 - δ / 3}{3} \geq \frac{{\sum }_{k ∈ {V}_{c} , k \neq p , q} {u}_{k} / 3 + {u}_{p} / 3 + {u}_{q} / 3 + {u}_{t} / 3 - δ / 3}{N} ⇒ {u}_{p} \geq δ / 3 + {r}_{p} 3$$

Similarly, for cluster head q and t, that is u_{q}≧δ/3+rₚ/3 and u₁≧δ/3+rₚ/3.

With the similar division method for eHCPS with K cluster heads, it can be deduced that the requirement for each cluster head is

u_{head}≧δ/K+rₚ/K. (15)

In HCPS, the departure or crash of the cluster head disrupted content delivery. The peers in the clusters are prevented from receiving the data from the departed cluster head, and therefore cannot serve the content to other peers. The peers will, thus, miss some data in playback and the viewing quality is degraded.

With multiple heads where each head is responsible for serving one sub-stream, eHCPS is able to alleviate the impact of cluster head departure/crash. The crash of one head has no influence on other heads hence will not affect other sub-stream distribution. Peers continue to receive partial streams from the remaining cluster heads. Using advanced coding techniques such as layer coding or MDC (multiple description coding), the peers can continue to playback with the received data until the departed cluster head is replaced. Compared with HCPS, eHCPS can forward more descriptions when a cluster head departs so is more robust.

eHCPS divides the source video streaming into multiple equal rate sub-streams. Each source sub-stream is delivered to cluster heads in the top-level cluster using “perfect” scheduling mechanism as described in PCT/US07/025,656 filed Dec. 14, 2007 entitled HIERARCHICALLY CLUSTERED P2P STREAMING SYSTEM and claiming priority of Provisional Application No. 60/919,035 filed Mar. 20, 2007 with the same inventors as the present invention. These cluster heads serve as source in the lower-level clusters. FIG. 3 depicts the layout of an eHCPS system.

FIG. 4 depicts the architecture of a peer in eHCPS. It receives the data content from multiple cluster heads as well as from other peers in the same cluster via the incoming queues. The data handler receives the content from the cluster heads and other peers in the cluster via the incoming queues. The data received by the data handler is stored in the playback buffer. The data stream from cluster heads are then pushed into the transmission queues for peers to which the data should be relayed. The cluster info database contains the cluster membership information for each sub-stream. The cluster membership is known globally in the centralized method of the present invention. For instance, in the first cluster in FIG. 3, node a1 is the cluster head responsible for sub-stream 1. Cluster a2 is the cluster head responsible for sub-stream 2. The other three nodes are peers receiving data from both a1 and a2. The cluster information is available to the data handler.

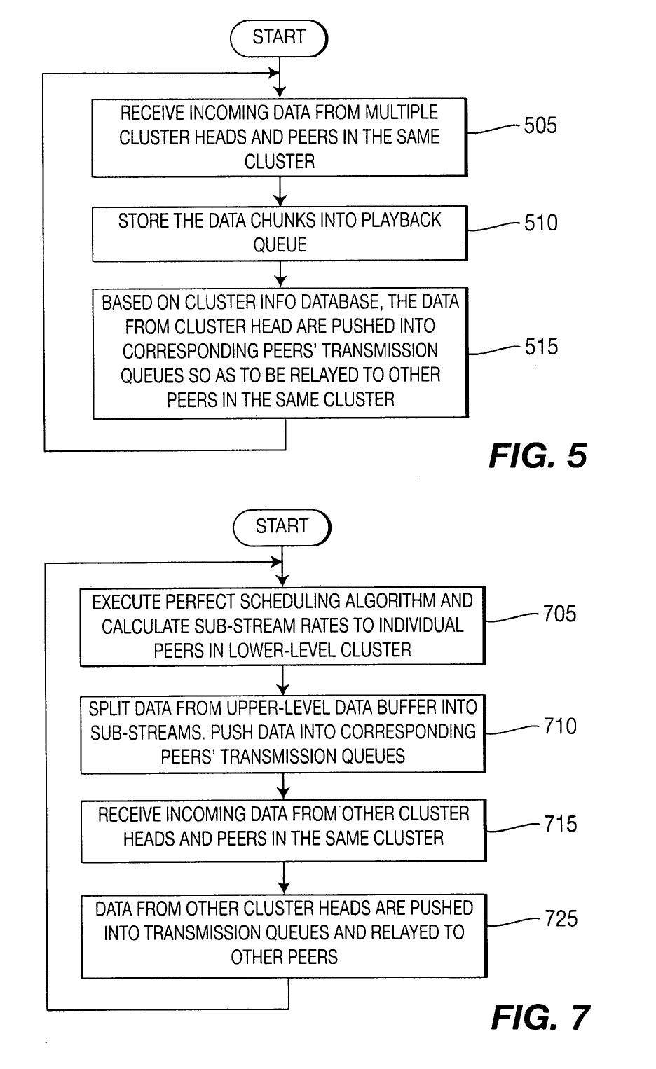

The flowchart of FIG. 5 illustrates the data handling process of a peer. At 505 the peer receives incoming data from multiple cluster heads and peers in the same cluster in its incoming queues. The received data is forwarded to the data handler of the peer which stores the received data into the playback buffer/queue at 510. Using the cluster info available from the cluster info database, the data handler pushes the data stored in the playback buffer into the transmission queues to be relayed to other peers in the same cluster at 515.

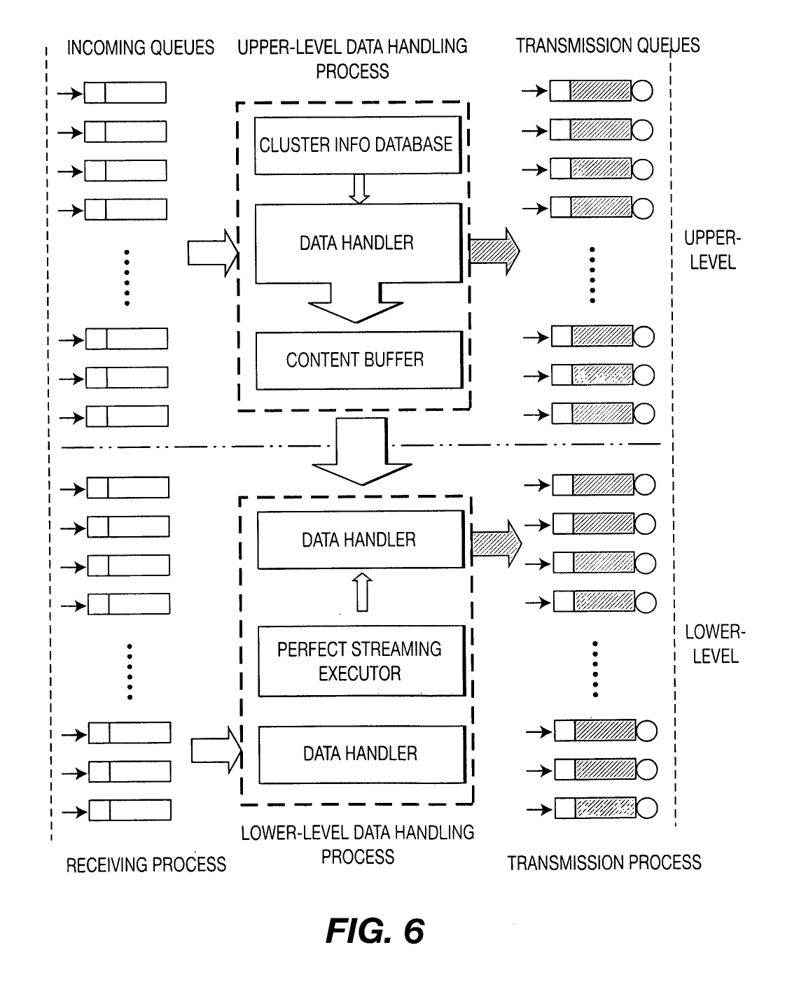

FIG. 6 depicts the architecture of a cluster head. A cluster head participates in two clusters: an upper-level cluster and a lower-level cluster. In the upper level cluster, the cluster head retrieves one sub-stream from the content server. In the lower-level cluster, the cluster head serves as the source for the sub-streams retrieved from the content server. Meanwhile, the cluster head also obtains sub-streams from other cluster heads in the same cluster as a normal peer. The sub-stream retrieved from the content server and the sub-streams received from other peers in the upper-level cluster are combined to form the full stream. The upper-level data handling process is the same as the data handling process for a peer (see FIG. 5). The upper-level data handler for the cluster head receives the data content from the content server as well as from other peers in the same cluster via the incoming queues. The data received by the data handler is stored in the content buffer, which in the case of a cluster head is a playback buffer from which the cluster head renders data/content. The data stream retrieved from the server is then pushed into the transmission queues for other upper-level peers to which the data should be relayed. The upper-level data handler stores received data into the content buffer. The data/content stored in the content buffer is then available to one of two lower-level data handlers. The lower-level data handling process includes two data handlers and a “perfect” scheduling executor. For the sub-stream that this cluster head serves as server, the “perfect” scheduling algorithm is then executed and stream rates to individual peers are calculated. Data from the upper-level content buffer is divided into streams based on the output of the “perfect” scheduling algorithm. Data is then pushed into corresponding lower-level peers' transmission queues and will be transmitted to lower level peers. The cluster head also behaves as a normal peer for the sub-streams served by other cluster heads in the same cluster. If the cluster head receives the data from another cluster head, it will relay the data to other lower-level peers. For the data relayed by other peers in the same cluster (cluster head for other sub-stream) it is stored in the content buffer and no further action is required because the other sub-stream cluster head is already serving this content to the other peers in the cluster.

The flowchart for lower-level data handling process of a cluster head is illustrated in FIG. 7. Data/content stored in a cluster head's content buffer is available to the cluster head's lower level data handler. The “perfect” scheduling algorithm is executed at 705 to calculate stream rates to the individual lower-level peers. The data handler in the middle splits the content retrieved from the content buffer into sub-streams and pushes the data into the transmission queues for the lower-level peers at 710. At 715 content is received from other cluster heads and peers in the same cluster. Note that a cluster head is a server for the sub-stream for which it is responsible. At the same time, it needs to retrieve other sub-streams from other cluster heads and peers in the same cluster. Cluster heads participate in all sub-stream distribution. At 725 data from other cluster heads are pushed into the transmission queues and relayed to other lower level peers

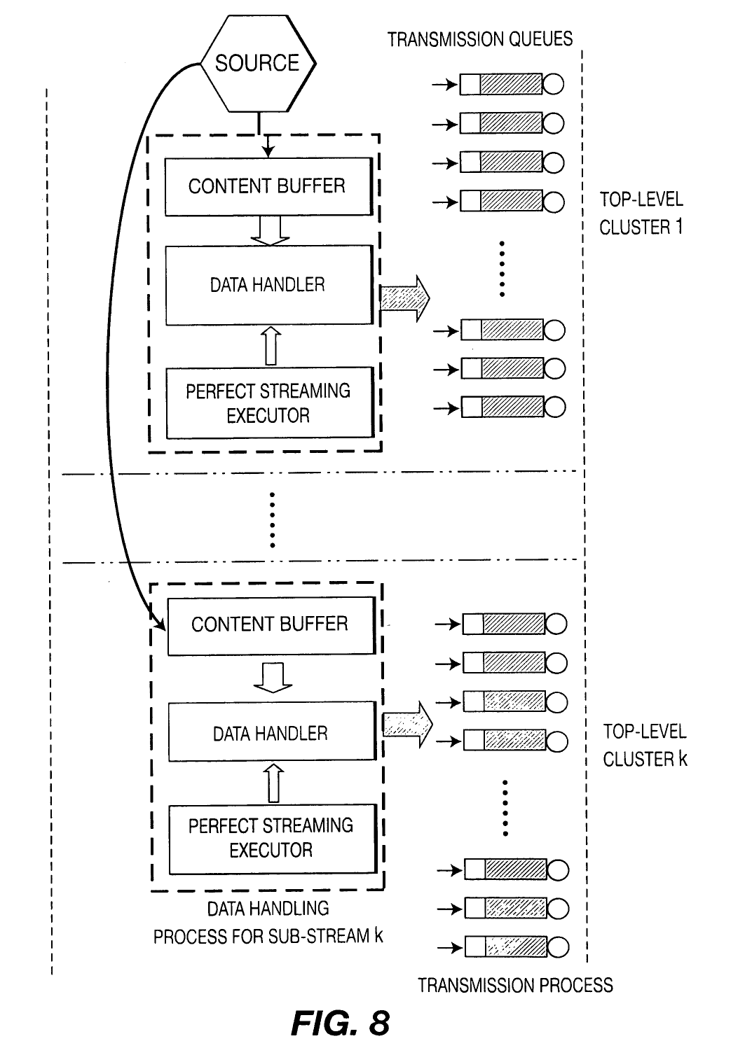

FIG. 8 depicts the architecture of the content/source server. The source server divides the original stream into k equal rate streams, where k is pre-defined configuration parameter. Typically k is set to be two but there may be more than two cluster heads per cluster. At the top level, one cluster is formed for each stream. The source server has one sub-server to server each top-level cluster. Each sub-server of the data handling process includes a content buffer, a data handler and a “perfect” streaming executor. The source/content is stored by the server in a content buffer. The data handler access the stored content and in accordance with the stream division determined by the “perfect” streaming executor, the data handler pushes the content into the transmission queues to be relayed to the upper-level cluster heads. K is the number of cluster heads. K is also the number of top-level clusters.

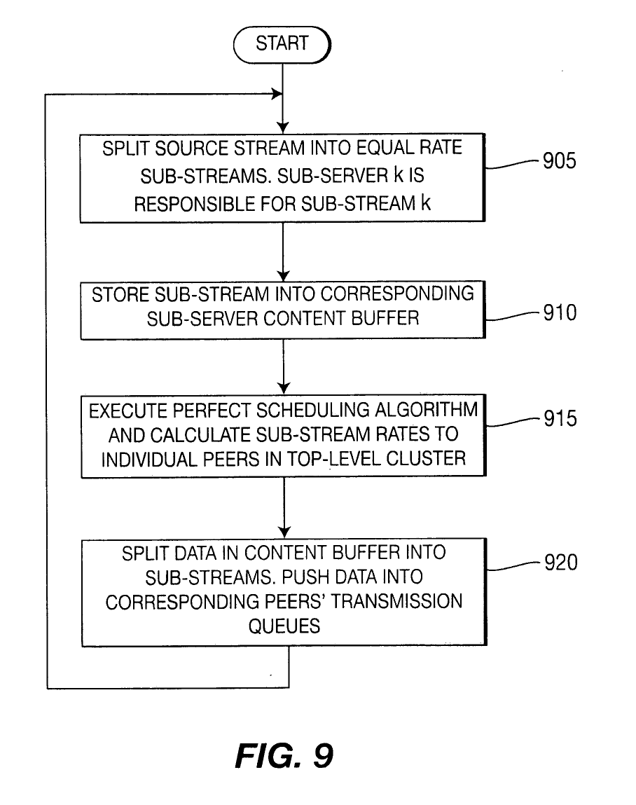

FIG. 9 is a flowchart illustrating the data handling process for a sub-server. The source/content server splits the stream into equal rate sub-streams at 905. A single sub-server is responsible for each sub-stream. For example, sub-server k is responsible for the k^{th} sub-stream. At 910, the sub-stream is stored into the corresponding sub-stream content buffer. The data handler for each sub-server accesses the content and executes the “perfect” scheduling algorithm to determine the sub-stream rates for the individual peers in the top-level cluster at 915. The content/data in the content buffer is split into sub-streams and pushed into the transmission queues for the corresponding top-level peers. The content/data is transmitted to peers by the transmission process.

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1. A method for performing live streaming of data, said method comprising:
receiving data from a plurality of cluster heads of a cluster of peers; and
forwarding said data to peers.

2. The method according to claim 1, further comprising:
storing said data in a buffer; and
rendering said stored data.

3. The method according to claim 1, wherein said peers are members of a same cluster.

4. An apparatus for performing live streaming of data, comprising:
means for receiving data from a plurality of cluster heads of a cluster of peers; and
means for forwarding said data to peers.

5. The apparatus according to claim 4, further comprising:
means for storing said data in a buffer; and
means for rendering said stored data.

6. The apparatus according to claim 4, wherein said peers are members of a same cluster.

7. A method for performing live streaming of data by a plurality cluster heads of a cluster of peers, said method comprising:
calculating a sub-stream rate;
splitting a stream of data into a plurality of data sub-streams; and
pushing said plurality of data sub-streams into corresponding transmission queues.

8. The method according to claim 7, further comprising receiving data.

9. An apparatus for performing live streaming of data by a plurality of cluster heads of a cluster of comprising:
means for calculating a plurality of sub-stream rates;
means for splitting a stream of data into a plurality of data sub-streams; and
means for pushing said plurality of data sub-streams into corresponding transmission queues.

10. The apparatus according to claim 9, further comprising means for receiving data.

11. A method for performing live streaming of data by a sub-server, said method comprising:
splitting a stream of source data into a plurality of equal rate data sub-streams;
storing said equal rate data sub-streams into a sub-server content buffer;
splitting said stored equal rate data sub-streams into a plurality of data sub-streams;
calculating a plurality of sub-stream rates; and
pushing said data sub-streams into corresponding transmission queues.

12. An apparatus for performing live streaming of data by a sub-server, comprising:
means for splitting a stream of source data into a plurality of equal rate data sub-streams;
means for storing said equal rate data sub-streams into a sub-server content buffer;
means for splitting said stored equal rate data sub-streams into a plurality of data sub-streams;
means for calculating a plurality of sub-stream rates; and
means for pushing said data sub-streams into corresponding transmission queues.
